(19) United States
(12) Patent Application Publication
(10) Pub. No.: US 2023/0274161 A1
(43) Pub. Date: Aug. 31, 2023

(54) ENTITY LINKING METHOD, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Jinxing YU, Beijing (CN); Minlong PENG, Beijing (CN); Mingming SUN, Beijing (CN); Ping LI, Sunnyvale, CA (US)

(73) Assignee: BEIJING BAIDU NETCOM SCIENCE TECHNOLOGY CO., LTD., Beijing (CN)

(21) Appl. No.: 17/940,059

(22) Filed: Sep. 8, 2022

(30) Foreign Application Priority Data
Feb. 25, 2022 (CN) 202210178163.3

(51) Int. Cl. G06N 5/02; G06F 16/903

(52) U.S. Cl. CPC G06N 5/022; G06F 16/90335

(57) ABSTRACT

There is provided an entity linking method, an electronic device, and a storage medium, which relates to the technical field of artificial intelligence such as machine learning, natural language processing, and intelligent search. A specific implementation solution involves: acquiring a target entity in a knowledge base and most relevant to a to-be-linked entity in a specified statement; and deciding, based on a linking decision strategy, whether to link the to-be-linked entity to the target entity in the knowledge base.

### CROSS-REFERENCE TO RELATED APPLICATIONS

The present application claims the priority of Chinese Patent Application No. 202210178163.3, filed on Feb. 25, 2022, with the title of “ENTITY LINKING METHOD AND APPARATUS, ELECTRONIC DEVICE, AND STORAGE MEDIUM.” The disclosure of the above application is incorporated herein by reference in its entirety.

### FIELD OF THE DISCLOSURE

The present disclosure relates to the technical field of computers, specifically to the technical field of artificial intelligence such as machine learning, natural language processing, and intelligent search, and particularly to an entity linking method, an electronic device, and a storage medium.

### BACKGROUND OF THE DISCLOSURE

An entity linking technology specifically refers to a technology of identifying an entity in text and linking the identified entity to one of a plurality of entities with the same name in a knowledge base such as a knowledge graph.

The knowledge base includes many entities with the same name but different attribute information. Moreover, rich background information such as description and attributes of each type of entities is recorded in the knowledge base. The background information may help to understand semantics of the text.

### SUMMARY OF THE DISCLOSURE

The present disclosure provides an entity linking method, an electronic device, and a storage medium.

According to one aspect of the present disclosure, an entity linking method is provided, including acquiring a target entity in a knowledge base and most relevant to a to-be-linked entity in a specified statement; and deciding, based on a preset linking decision strategy, whether to link the to-be-linked entity to the target entity in the knowledge base.

According to another aspect of the present disclosure, an electronic device is provided, including at least one processor; and a memory communicatively connected with the at least one processor; wherein the memory stores instructions executable by the at least one processor, and the instructions are executed by the at least one processor to enable the at least one processor to perform an entity linking method, wherein the entity linking method includes acquiring a target entity in a knowledge base and most relevant to a to-be-linked entity in a specified statement; and deciding, based on a preset linking decision strategy, whether to link the to-be-linked entity to the target entity in the knowledge base.

According to still another aspect of the present disclosure, there is provided a non-transitory computer readable storage medium with computer instructions stored thereon, wherein the computer instructions are used for causing an entity linking method, wherein the entity linking method includes: acquiring a target entity in a knowledge base and most relevant to a to-be-linked entity in a specified statement; and deciding, based on a preset linking decision strategy, whether to link the to-be-linked entity to the target entity in the knowledge base.

It should be understood that the content described in this part is neither intended to identify key or significant features of the embodiments of the present disclosure, nor intended to limit the scope of the present disclosure. Other features of the present disclosure will be made easier to understand through the following description.

### BRIEF DESCRIPTION OF DRAWINGS

The accompanying drawings are intended to provide a better understanding of the solutions and do not constitute a limitation on the present disclosure. In the drawings,

FIG. 1 is a schematic diagram according to a first embodiment of the present disclosure;

FIG. 2 is a schematic diagram according to a second embodiment of the present disclosure;

FIG. 3 is a schematic diagram according to a third embodiment of the present disclosure;

FIG. 4 is a diagram of an operating principle of a model according to the present disclosure;

FIG. 5 is a schematic diagram according to a fourth embodiment of the present disclosure;

FIG. 6 is a schematic diagram according to a fifth embodiment of the present disclosure; and

FIG. 7 is a block diagram of an electronic device configured to implement the method according to an embodiment of the present disclosure.

### DETAILED DESCRIPTION OF PREFERRED EMBODIMENTS

Exemplary embodiments of the present disclosure are illustrated below with reference to the accompanying drawings, which include various details of the present disclosure to facilitate understanding and should be considered only as exemplary. Therefore, those of ordinary skill in the art should be aware that various changes and modifications can be made to the embodiments described herein without departing from the scope and spirit of the present disclosure. Similarly, for clarity and simplicity, descriptions of well-known functions and structures are omitted in the following description.

Obviously, the embodiments described are some of rather than all of the embodiments of the present disclosure. All other embodiments acquired by those of ordinary skill in the art without creative efforts based on the embodiments of the present disclosure fall within the protection scope of the present disclosure.

It is to be noted that the terminal device involved in the embodiments of the present disclosure may include, but is not limited to, smart devices such as mobile phones, personal digital assistants (PDAs), wireless handheld devices, and tablet computers. The display device may include, but is not limited to, devices with a display function such as personal computers and televisions.

In addition, the term “and/or” herein is merely an association relationship describing associated objects, indicating that three relationships may exist. For example, A and/or B indicates that there are three cases of A alone, A and B together, and B alone. Besides, the character “/” herein generally means that associated objects before and after it are in an “or” relationship.

Based on the principle of entity linking, many entity linking realization methods are adopted in the related art. For example, a vector representation of a to-be-linked entity and vector representations of candidate entities may be constructed to calculate similarity scores between the to-be-linked entity and the candidate entities, and the candidate entity with the highest score is acquired for linking. However, the entity linking in the related art has poor accuracy.

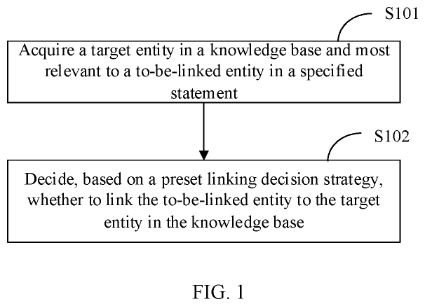

FIG. 1 is a schematic diagram according to a first embodiment of the present disclosure. As shown in FIG. 1, this embodiment provides an entity linking method, which may be applied to an entity linking apparatus and may specifically include the following steps.

In S101, a target entity in a knowledge base and most relevant to a to-be-linked entity in a specified statement is acquired.

In S102, it is decided, based on a linking decision strategy, whether to link the to-be-linked entity to the target entity in the knowledge base.

The knowledge base in this embodiment may refer to a database in the form of a knowledge graph and used to store a variety of entity information. For an entity with any name, a plurality of types of entities with the same name may be stored in the knowledge base. At the same time, description information of each type of entities is recorded therein. For example, the description information of entities may include summaries, types, introductions, attribute relationships, and so on. The description information of each type of entities can help to understand the entities of the type, and then can help users understand semantics of entities including the type.

For any specified statement, in this embodiment, an entity in the specified statement is required to be identified first. In order to be distinguished from entities in the knowledge base, an entity identified in the specified statement that is to be linked may also be referred to as an entity mention in the related art, and may be understood as an entity mentioned in the specified statement. This embodiment is intended to link an identified entity to a target entity with the same name in an entity base. Therefore, the identified entity is the to-be-linked entity in this embodiment.

A type of the to-be-linked entity in this embodiment may include a person name, a place name, a film work name, and the like.

In this embodiment, the deciding, based on a preset linking decision strategy, whether to link the to-be-linked entity to the target entity in the knowledge base includes not linking the to-be-linked entity to the target entity in the knowledge base. The target entity is most relevant to the to-be-linked entity, which is only relative to other entities in the knowledge base. Therefore, if the to-be-linked entity is not linked to the target entity in the knowledge base according to the preset linking decision strategy, which may indicate that the to-be-linked entity has poor accuracy in being linked to any entity of the same name in the knowledge base and is more accurate as a new entity, in this case, the to-be-linked entity may not be linked to the target entity in the knowledge base. Unlike the related art in which a highest score always exists based on the similarity scores, according to the highest score, the to-be-linked entity is linked to an entity with the same name corresponding to the highest score, which definitely has a problem of incorrect linking. Therefore, the entity linking method in this embodiment can improve accuracy of entity linking.

According to the entity linking method in this embodiment, after a target entity in a knowledge base and most relevant to a to-be-linked entity in a specified statement is acquired, it is decided, based on a preset linking decision strategy, whether to link the to-be-linked entity to the target entity in the knowledge base, instead of directly linking the to-be-linked entity to the most relevant target entity, which can effectively reduce occurrence of incorrect linking and then can effectively improve accuracy of entity linking.

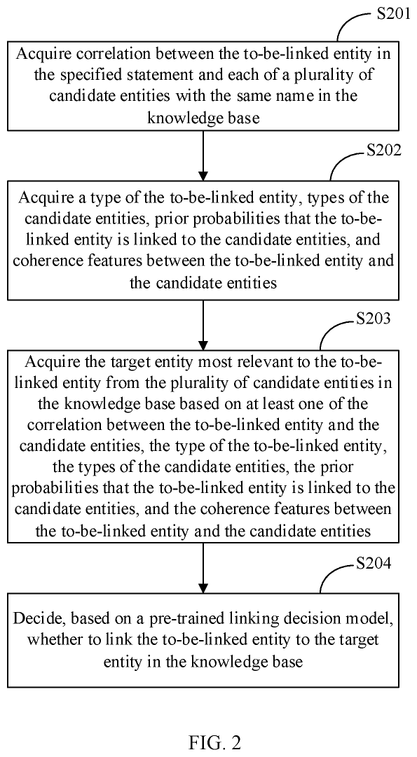

FIG. 2 is a schematic diagram according to a second embodiment of the present disclosure. As shown in FIG. 2, an entity linking method in this embodiment further describes the technical solution of the present disclosure in more detail on the basis of the technical solution in the embodiment shown in FIG. 1. As shown in FIG. 2, the entity linking method in this embodiment may specifically include the following steps.

In S201, correlation between the to-be-linked entity in the specified statement and each of a plurality of candidate entities with the same name in the knowledge base is acquired.

Optionally, in one embodiment of the present disclosure, prior to step S201, the entity in the specified statement may be identified by using a pre-trained entity identification model. The identified entity is the to-be-linked entity in this embodiment.

The entity identification model in this embodiment may be trained in advance with a plurality of training samples. Each of the training samples includes a training statement and a labeled entity. After the entity identification model is trained with the plurality of training samples, the entity identification model can learn a capability of identifying entities.

Optionally, in one embodiment of the present disclosure, prior to step S201, the entity may be identified from the specified statement by using a preset entity filtering rule.

No matter which manner is adopted, an entity can be accurately identified from any specified statement, and the identified entity can be used as a to-be-linked entity. Next, by use of the technical solution in this embodiment, correlation between the to-be-linked entity and candidate entities with the same name in the knowledge base is acquired and analyzed.

For example, in this embodiment, correlation between text information of the to-be-linked entity and text information of attribute description of the candidate entities can be calculated as the correlation between the two. Alternatively, correlation between a type of the to-be-linked entity and types of the candidate entities can be calculated as the correlation between the two. Alternatively, correlation between description information of the to-be-linked entity, context, and the candidate entities can be calculated as the correlation between the two. Alternatively, correlation between any other information or combination of the to-be-linked entity and any other information or combination of the candidate entities can be calculated as the correlation between the two. Examples are not described one by one herein. The higher the correlation, the more similar the to-be-linked entity is to the candidate entity. In this embodiment, the correlation may be expressed by a probability value between [0,1]. The closer to 1, the more similar the two are. Otherwise, the closer to 0, the less similar the two are.

In S202, a type of the to-be-linked entity, types of the candidate entities, prior probabilities that the to-be-linked entity is linked to the candidate entities, and coherence features between the to-be-linked entity and the candidate entities are acquired.

In this embodiment, the type of the to-be-linked entity, that is, an entity mention type, may be predicted based on a pre-trained entity type identification model. For example, text and a to-be-linked entity in the text are inputted together to the entity type identification model. The entity type identification model may predict and output a type of the to-be-linked entity.

Alternatively, the context of the to-be-linked entity in the text may be analyzed to identify a type of the to-be-linked entity. For example, a song is described in the context of the text. After analysis, it can be inferred that the to-be-linked entity refers to a song name. Alternatively, a book is described in the context of the text. After analysis, it can be inferred that the to-be-linked entity refers to a book title.

The types of the candidate entities, that is, entity types, are recorded in attribute description of the candidate entities in the knowledge base and can be directly acquired.

The prior probabilities that the to-be-linked entity is linked to the candidate entities are link-count prior. Specifically, statistical probabilities that the to-be-linked entity is linked to the candidate entities may be calculated based on a number of frequencies at which entities with the same name as the to-be-linked entity are linked to the candidate entities and a total number of frequencies at which the entities are linked. Then, the prior probabilities that the to-be-linked entity is linked to the candidate entities are calculated based on the obtained statistical probabilities. For example, optionally, the prior probabilities may be directly equal to the statistical probabilities; or the prior probabilities may take logarithms of or perform other mathematical operations on the statistical probabilities. No matter which manner is adopted, the prior probabilities are proportional to the statistical probabilities all the time.

The coherence features between the to-be-linked entity and the candidate entities may refer to common information between context information in the specified statement where the to-be-linked entity is located and description information of the candidate entities; or refer to common text information between text information of other entities in the specified statement where the to-be-linked entity is located and attribute description of the candidate entities, i.e., mention-entity coherence.

In S203, the target entity most relevant to the to-be-linked entity is acquired from the plurality of candidate entities in the knowledge base based on at least one of the correlation between the to-be-linked entity and the candidate entities, the type of the to-be-linked entity, the types of the candidate entities, the prior probabilities that the to-be-linked entity is linked to the candidate entities, and the coherence features between the to-be-linked entity and the candidate entities.

In this embodiment, in the process of acquiring the target entity most relevant to the to-be-linked entity, the more the correlation between the to-be-linked entity and the candidate entities, the type of the to-be-linked entity, the types of the candidate entities, the prior probabilities that the to-be-linked entity is linked to the candidate entities, and the coherence features between the to-be-linked entity and the candidate entities is/are referenced to, the more accurate the acquired target entity.

Optionally, in this embodiment, one, two or more most relevant target entities may be acquired.

Steps S201 to S203 are one implementation of step S101 in the embodiment shown in FIG. 1.

In S204, it is decided, based on a pre-trained linking decision model, whether to link the to-be-linked entity to the target entity in the knowledge base.

In this embodiment, the linking decision model may be a gbdt binary-classification model. After pre-training, the linking decision model may output a probability between [0,1] based on information of the to-be-linked entity and information of the target entity. In practical applications, a preset probability threshold may be set based on a field of text to which the specified statement belongs. If the output probability is greater than the preset probability threshold, the to-be-linked entity can be linked to the target entity in the knowledge base. Otherwise, there is no need to link the to-be-linked entity to the target entity in the knowledge base. When there is no need to link the to-be-linked entity to the target entity in the knowledge base, an NIL entity may be returned. In this case, it may be known that the to-be-linked entity is a new entity.

According to the entity linking method in this embodiment, by acquiring the target entity most relevant to the to-be-linked entity from the plurality of candidate entities in the knowledge base based on at least one of the correlation between the to-be-linked entity and the candidate entities, the type of the to-be-linked entity, the types of the candidate entities, the prior probabilities that the to-be-linked entity is linked to the candidate entities, and the coherence features between the to-be-linked entity and the candidate entities, accuracy of the acquired target entity can be effectively improved. Then, it is decided, based on a pre-trained linking decision model, whether to link the to-be-linked entity to the target entity in the knowledge base, which can effectively improve accuracy of a linking decision.

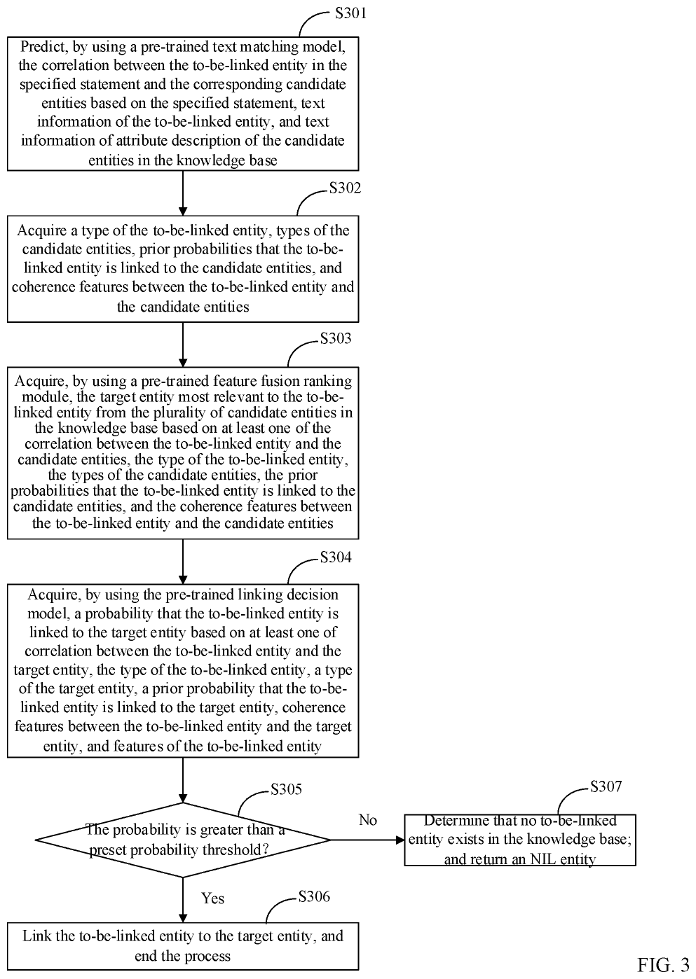

FIG. 3 is a schematic diagram according to a third embodiment of the present disclosure. As shown in FIG. 3, an entity linking method in this embodiment further describes the technical solution of the present disclosure in more detail on the basis of the technical solution in the embodiment shown in FIG. 2. As shown in FIG. 3, the entity linking method in this embodiment may specifically include the following steps.

In S301, the correlation between the to-be-linked entity in the specified statement and the corresponding candidate entities is predicted based on the specified statement, text information of the to-be-linked entity, and text information of attribute description of the candidate entities in the knowledge base by using a pre-trained text matching model.

Specifically, input of the text matching model may include information in two aspects: relevant text information of the to-be-linked entity and relevant text information of the candidate entities in the knowledge base. The relevant text information of the to-be-linked entity may include the specified statement of the to-be-linked entity, that is, text information of the to-be-linked entity and other text information in the specified statement. The relevant text information of the candidate entities refers to text information of attribute description of the candidate entities.

In the entity linking method of this embodiment, the input of the text matching model includes: 1) a specified statement S=[w₁, w₂, . . . , wₙ], the specified statement S including a plurality of words; 2) an entity m in the specified statement S, m being an entity name phrase in S, including one or more words, for example, m being “Li XX”; and 3) k candidate entities [e₁, e₂, . . . , eₖ] with the same name as m in the knowledge base. For example, the knowledge base may include candidate entities such as an ancient poet Li XX, a game hero Li XX, and a singer A's song Li XX, and attribute description of the candidate entities is recorded in the knowledge base, which may include, for example, summaries, types, introductions, attribute relationships, and so on. The model is required to output an NIL entity or a selected linked entity eᵢ. eᵢ is one of the k candidate entities. When the number of the candidate entities in the knowledge base is k=1, it is referred to as monosemantic linking. When the number of the candidate entities is greater than 1, it is referred to as polysemantic linking.

When the text matching model of this embodiment is in use, input information includes 1), 2), and relevant information of one of the candidate entities in 3). The text matching model outputs a probability between [0,1], which represents text correlation between the to-be-linked entity and the candidate entity in the knowledge base. The text matching model of this embodiment is a binary-classification model. If the to-be-linked entity m should be linked to the candidate entity eᵢ, a label may theoretically be 1. Otherwise, the label may theoretically be 0.

A pre-trained language model, such as Bert or Ernie, may be used as the text matching model of this embodiment to model text correlation between the to-be-linked entity and the candidate entity. The pre-trained language model may load pre-trained model parameters and then fine-tune a text matching task to obtain a final text matching model.

In specific use, processed text is inputted to the text matching model. For example, for input of text of the to-be-linked entity and the specified statement, the specified statement may be inputted, and special characters of [unused1] and [unused2] are respectively added to left and right positions of the to-be-linked entity in the specified statement to label a position of the to-be-linked entity in the specified statement. For the candidate entities in the knowledge base, the candidate entities have a variety of attribute description, including summaries, types, introduces, attribute relationships, and so on. Text of different attributes may be labeled with a format of “attribute keyword description: attribute description”. The text of different attributes is spliced by using a special character [unused3] as a separator. The special characters [unused1], [unused2], and [unused3] are characters reserved by the pre-trained language model. An embedding representation in the model may be learned during task training.

Further optionally, in order to further improve the accuracy of the correlation between the to-be-linked entity and the candidate entities, the correlation between the to-be-linked entity in the specified statement and the corresponding candidate entities is predicted based on the specified statement, text information of the to-be-linked entity, text information of attribute description of the candidate entities in the knowledge base, and document title information of the specified statement by using a pre-trained text matching model.

That is, in the text matching model in this embodiment, the document title information of the specified statement may be additionally inputted as supplementary text, which can solve the problem of insufficient information of the to-be-linked entity and the specified statement and then can improve accuracy of the correlation between the to-be-linked entity in the specified statement and the corresponding candidate entities.

In this case, the corresponding input to the text matching model may be sample data in the format of (S, m, e y), where S, m, eᵢ, y denote the specified statement, the to-be-linked entity, the candidate entity, and a label (0 or 1) respectively.

The pre-trained text matching model obtains a matching vector PretrainLM (S, m, eᵢ)_{CLS} based on the above input information, and then uses a full link network and a sigmoid activation function to obtain a predicted probability of the correlation between the to-be-linked entity and the candidate entity:

prob(S,m,eᵢ)=σ(w^{T}PretrainLM(S,m,e_i)_{CLS})

where w^{T} denotes a learnable parameter vector; and σ( ) denotes the sigmoid activation function.

During the training of the text matching model, mini-batch data may be sampled, and the following loss function L may be used to train and update model parameters:

L=−y log(prob(s,m,eᵢ))−(1−y)log(1−prob(s,m,eᵢ)).

where y denotes a label during the training, indicating whether the linking is correct. If yes, the value is 1. If no, the value is 0.

During the training of the text matching model, an accuracy rate, a recall rate, and F1 of entity linking of models on a verification set may be evaluated, and then the model with the maximum F1 of entity linking on the verification set is selected for subsequent prediction.

After completion of the training of the text matching model, correlation of text semantics between a to-be-linked entity in a sample and a candidate entity in the knowledge base may be predicted asprob (S, m, eᵢ).

During the training of the text matching model in this embodiment, training data may be collected based on internal links in a website. The “internal links” are partially added manually by a creator, and partially added automatically by an entity linking algorithm. The “internal links” provide hyperlinks for entity mentions to entities with the same name in the knowledge base. According to the structured layout of a web page, in which regions the “internal links” have relatively high accuracy can be evaluated and statistically analyzed, and the “internal links” with relatively high accuracy can be selected as training samples.

In the text matching model, partial data may be sampled by using polysemantically linked internal link data to obtain a training sample set. The use of the polysemantically linked internal link data is because monosemantically linked data has no entity candidate of negative samples, which cannot provide sufficient negative sample supervision signals to promote full learning of the text matching model.

Since the accuracy of “internal link” data is not 100%, partial data may be manually annotated for collection of verification data and test data of the text matching model. Part serves as the verification data to select a better text matching model during the training. Part serves as the test data to evaluate an effect of the text matching model.

Step S301 is one implementation of step S201 in the embodiment shown in FIG. 2, and may be realized by the text matching model, which can effectively improve accuracy of the correlation between the to-be-linked entity and the candidate entities.

In S302, a type of the to-be-linked entity, types of the candidate entities, prior probabilities that the to-be-linked entity is linked to the candidate entities, and coherence features between the to-be-linked entity and the candidate entities are acquired.

A specific acquisition process may be obtained with reference to step S202 in the embodiment shown in FIG. 2. Details are not described herein.

In S303, the target entity most relevant to the to-be-linked entity is acquired from the plurality of candidate entities in the knowledge base based on at least one of the correlation between the to-be-linked entity and the candidate entities, the type of the to-be-linked entity, the types of the candidate entities, the prior probabilities that the to-be-linked entity is linked to the candidate entities, and the coherence features between the to-be-linked entity and the candidate entities by using a pre-trained feature fusion ranking model.

In practical applications, preferably, the feature fusion ranking model may acquire the target entity most relevant to the to-be-linked entity from the plurality of candidate entities in the knowledge base based on all the features acquired in step S301 and step S302. In this way, the acquired target entity is the most accurate.

In this embodiment, input to the feature fusion ranking model includes: 1) a specified statement S=[w₁, w₂, . . . , wₙ], the specified statement S including a plurality of words; 2) a to-be-linked entity m in the specified statement S, that is, m being an entity name phrase in S, including one or more words; and 3) k candidate entities [e₁, e₂, . . . eₖ] with the same name as m in the knowledge base, that is, the knowledge base including k candidate entities with the same name as the to-be-linked entity m.

In this embodiment, the feature fusion ranking model is further configured to rank the k candidate entities to select a top1 entity eᵢ with the highest core. eᵢ is one of the k candidate entities.

In this embodiment, the feature fusion ranking model may rank the candidate entities according to features of the candidate entities. Specifically, a decision tree algorithm may be integrated by gbdt lambada rank. During the training of the feature fusion ranking model, an optimal feature fusion ranking model is selected using an ndcg index on the validation set.

In the prediction, the optimal feature fusion ranking model selected during the training may be loaded to rank all candidate entities corresponding to the to-be-linked entity and select the Top1 candidate entity with the highest score as the target entity.

Step S303 is one implementation of step S203 in the embodiment shown in FIG. 2. Specifically, in the implementation, the implementation by the feature fusion ranking model can improve accuracy and intelligence of the most relevant target entity acquired.

In S304, a probability that the to-be-linked entity is linked to the target entity is acquired based on at least one of correlation between the to-be-linked entity and the target entity, the type of the to-be-linked entity, a type of the target entity, a prior probability that the to-be-linked entity is linked to the target entity, coherence features between the to-be-linked entity and the target entity, and features of the to-be-linked entity by using the pre-trained linking decision model.

In the step, when the linking decision model is used to acquire the probability that the to-be-linked entity is linked to the target entity, in addition to the features described in step S303, features of the to-be-linked entity are also added. For example, the features of the to-be-linked entity may include feature information such as a length of text of the to-be-linked entity. The features of the to-be-linked entity, such as the length of text, are the same for different candidate entities, which are not helpful for ranking the candidate entities. However, such features are helpful for determining whether the to-be-linked entity is a new entity.

Preferably, in this embodiment, input information of the linking decision model includes all the feature information described in step S304. The more the inputted feature information, the more accurate the probability predicted by the linking decision model that the to-be-linked entity is linked to the target entity.

In this embodiment, for the Top 1 target entity outputted by the feature fusion ranking model, the linking decision model is required to integrate the above features to predict whether to link the to-be-linked entity to the Top1 target entity. Modeling of the problem is also a binary-classification task. A gbdt binary-classification model may be used.

In a training stage of the linking decision model, all candidate entities of all polysemantically linked data can be used as binary-classification training samples. If one candidate entity is an entity to be linked, a target label predicted by the model is 1. Otherwise, the target label is 0.

In a prediction stage, the linking decision model is required only to predict a linking probability of a Top1 knowledge base entity outputted by the feature fusion ranking model.

In the step, by use of the linking decision model, accuracy of the probability that the to-be-linked entity is linked to the target entity can be effectively improved.

In S305, it is judged whether the probability is greater than a preset probability threshold. If yes, step S306 is performed. If no, step S307 is performed.

In S306, the to-be-linked entity is linked to the target entity, and the process ends.

In S307, it is determined that no to-be-linked entity exists in the knowledge base; and an NIL entity is returned.

In this case, returning NIL means that the knowledge base includes no target entity corresponding to the to-be-linked entity, which indicates that the to-be-linked entity is a new entity.

For the preset probability threshold in this embodiment, in use, different candidate probability thresholds may be set on test data according to the output of the linking decision model, and then accuracy rates and recall rates of the entity linking corresponding to the candidate probability thresholds are calculated. Then, a curve of accuracy rate vs. recall rate may be plotted. Moreover, an optimal preset probability threshold is selected according to an accuracy rate and a recall rate required by a service. For example, according to an optimal accuracy rate required by the service, the corresponding candidate probability threshold when the accuracy rate is greater than the optimal accuracy rate and the recall rate is maximum may be acquired as the preset probability threshold.

If the probability predicated and outputted by the linking decision model that the to-be-linked entity is linked to the target entity is lower than the preset probability threshold, an NIL entity is finally decided and outputted. If the probability is higher than the preset probability threshold, it is decided that the to-be-linked entity can be linked to the Top1 target entity selected by the feature fusion ranking model.

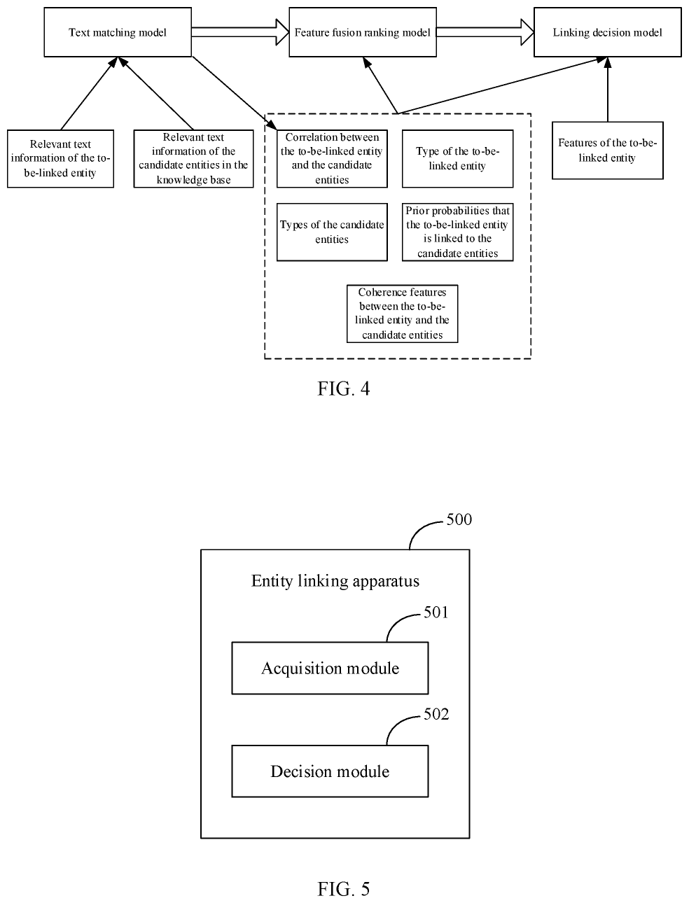

Based on the above, it can be known that the entity linking method in this embodiment is realized based on the text matching model, the feature fusion ranking model, and the linking decision model. An operating principle thereof may be shown in FIG. 4.

According to the entity linking method in this embodiment, entity linking is realized using the text matching model, the feature fusion ranking model, and the linking decision model, which can effectively improve accuracy of the target entity acquired by entity linking as well as increase intelligence of the entire solution.

The entity linking method in this embodiment may be applied to a search scenario, a recommendation scenario, a website internal link scenario, and the like.

For example, a user's search query is understood in the search scenario. For an entity mention included in the user's search query, that is, a to-be-linked entity, the to-be-linked entity may be linked to an entity with the same name in the knowledge base with the above entity linking method in this embodiment, which can help understand the user's search intention based on attribute description of the entity linked to, so as to meet the user's search requirement to the greatest extent.

For example, content such as news or video is understood in the recommendation scenario. In the recommendation scenario, recommended items such as news, long video, and short video may include entity mentions in titles, that is, to-be-linked entities. The to-be-linked entities are linked to entities with the same name in the knowledge base, and external information such as attribute description of the entities with the same name in the knowledge base can be used to better understand and describe the recommended items. Thus, a recommendation effect is improved, and user experience of recommended products is improved, manifested as improvement of core indexes such as daily active users (DAUs) and user duration.

For example, in a website, “an internal link” may be automatically generated on a web page with the above entity linking method in this embodiment, that is, a hyperlink that links a to-be-linked entity on the page to another page about a target entity with the same name. An “internal link” redirection error may also be automatically detected, and error correction suggestions are provided. In this way, accuracy and authority of products using the internal links in the website can be improved, and connections between entries in the website can be strengthened, bringing better user experience.

FIG. 5 is a schematic diagram according to a fourth embodiment of the present disclosure. As shown in FIG. 5, this embodiment provides an entity linking apparatus 500, including an acquisition module 501 configured to acquire a target entity in a knowledge base and most relevant to a to-be-linked entity in a specified statement; and a decision module 502 configured to decide, based on a linking decision strategy, whether to link the to-be-linked entity to the target entity in the knowledge base.

An implementation principle and a technical effect of the entity linking apparatus 500 in this embodiment realizing entity linking by using the above modules are the same as those in the above related method embodiment. Details may be obtained with reference to the description in the above related method embodiment, and are not described herein.

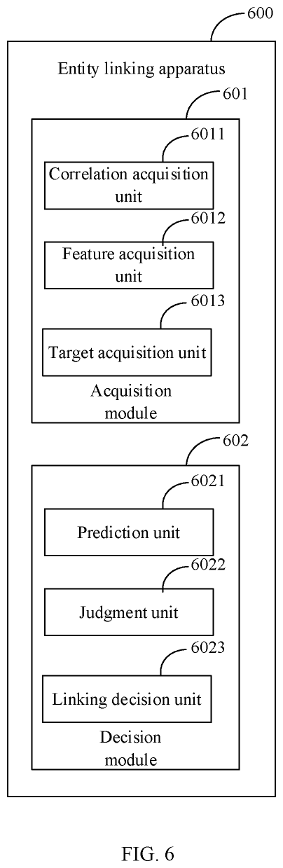

FIG. 6 is a schematic diagram according to a fifth embodiment of the present disclosure. As shown in FIG. 6, this embodiment provides an entity linking apparatus 600, including modules with the same names and the same functions as those in FIG. 5, i.e., an acquisition module 601 and a decision module 602.

Further optionally, in this embodiment, the acquisition module 601 includes a correlation acquisition unit 6011 configured to acquire correlation between the to-be-linked entity in the specified statement and each of a plurality of candidate entities with the same name in the knowledge base; a feature acquisition unit 6012 configured to acquire a type of the to-be-linked entity, types of the candidate entities, prior probabilities that the to-be-linked entity is linked to the candidate entities, and coherence features between the to-be-linked entity and the candidate entities; and a target acquisition unit 6013 configured to acquire the target entity most relevant to the to-be-linked entity from the plurality of candidate entities in the knowledge base based on at least one of the correlation between the to-be-linked entity and the candidate entities, the type of the to-be-linked entity, the types of the candidate entities, the prior probabilities that the to-be-linked entity is linked to the candidate entities, and the coherence features between the to-be-linked entity and the candidate entities.

Further optionally, in one embodiment of the present disclosure, the correlation acquisition unit 6011 is configured to predict, by using a pre-trained text matching model, the correlation between the to-be-linked entity in the specified statement and the corresponding candidate entities based on the specified statement, text information of the to-be-linked entity, and text information of attribute description of the candidate entities in the knowledge base.

Further optionally, in one embodiment of the present disclosure, the target acquisition unit 6013 is configured to acquire, by using a pre-trained feature fusion ranking module, the target entity most relevant to the to-be-linked entity from the plurality of candidate entities in the knowledge base based on at least one of the correlation between the to-be-linked entity and the candidate entities, the type of the to-be-linked entity, the types of the candidate entities, the prior probabilities that the to-be-linked entity is linked to the candidate entities, and the coherence features between the to-be-linked entity and the candidate entities.

Further optionally, in one embodiment of the present disclosure, the decision module 602 is configured to decide, based on a pre-trained linking decision model, whether to link the to-be-linked entity to the target entity in the knowledge base.

Further optionally, as shown in FIG. 6, in one embodiment of the present disclosure, the decision module 602 includes a prediction unit 6021 configured to acquire, by using the pre-trained linking decision model, a probability that the to-be-linked entity is linked to the target entity based on at least one of correlation between the to-be-linked entity and the target entity, the type of the to-be-linked entity, a type of the target entity, a prior probability that the to-be-linked entity is linked to the target entity, coherence features between the to-be-linked entity and the target entity, and features of the to-be-linked entity; a judgment unit 6022 configured to judge whether the probability is greater than a preset probability threshold; and a linking decision unit 6023 configured to link the to-be-linked entity to the target entity if yes.

Further optionally, in one embodiment of the present disclosure, the linking decision unit 6023 is further configured to determine that no to-be-linked entity exists in the knowledge base if the probability is no greater than the preset probability threshold.

An implementation principle and a technical effect of the entity linking apparatus 600 in this embodiment realizing entity linking by using the above modules are the same as those in the above related method embodiment. Details may be obtained with reference to the description in the above related method embodiment, and are not described herein.

Acquisition, storage, and application of users' personal information involved in the technical solutions of the present disclosure comply with relevant laws and regulations, and do not violate public order and moral.

According to embodiments of the present disclosure, the present disclosure further provides an electronic device, a readable storage medium, and a computer program product.

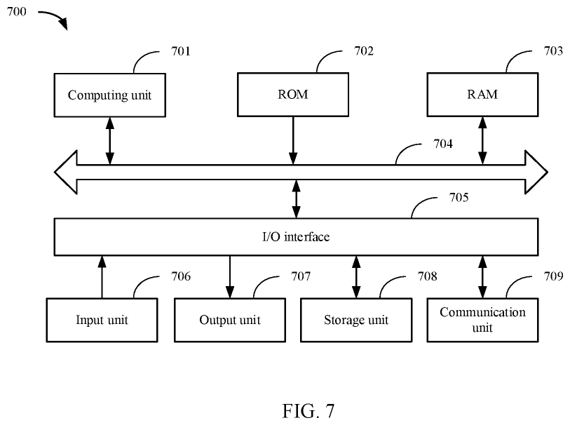

FIG. 7 is a schematic block diagram of an exemplary electronic device 700 configured to implement an embodiment of the present disclosure. The electronic device is intended to represent various forms of digital computers, such as laptops, desktops, workbenches, PDAs, servers, blade servers, mainframe computers and other suitable computers. The electronic device may further represent various forms of mobile devices, such as PDAs, cellular phones, smart phones, wearable devices and other similar computing devices. The components, their connections and relationships, and their functions shown herein are examples only, and are not intended to limit the implementation of the present disclosure as described and/or required herein.

As shown in FIG. 7, the device 700 includes a computing unit 701, which may perform various suitable actions and processing according to a computer program stored in a read-only memory (ROM) 702 or a computer program loaded from a storage unit 708 into a random access memory (RAM) 703. The RAM 703 may also store various programs and data required to operate the device 700. The computing unit 701, the ROM 702 and the RAM 703 are connected to one another by a bus 704. An input/output (I/O) interface 705 is also connected to the bus 704.

A plurality of components in the device 700 are connected to the I/O interface 705, including an input unit 706, such as a keyboard and a mouse; an output unit 707, such as various displays and speakers; a storage unit 708, such as disks and discs; and a communication unit 709, such as a network card, a modem and a wireless communication transceiver. The communication unit 709 allows the device 700 to exchange information/data with other devices over computer networks such as the Internet and/or various telecommunications networks.

The computing unit 701 may be a variety of general-purpose and/or special-purpose processing components with processing and computing capabilities. Some examples of the computing unit 701 include, but are not limited to, a central processing unit (CPU), a graphics processing unit (GPU), various artificial intelligence (AI) computing chips, various computing units that run machine learning model algorithms, a digital signal processor (DSP), and any appropriate processor, controller or microcontroller, etc. The computing unit 701 performs the methods and processing described above, such as the method in the present disclosure. For example, in some embodiments, the method in the present disclosure may be implemented as a computer software program that is tangibly embodied in a machine-readable medium, such as the storage unit 708. In some embodiments, part or all of a computer program may be loaded and/or installed on the device 700 via the ROM 702 and/or the communication unit 709. One or more steps of the method in the present disclosure described above may be performed when the computer program is loaded into the RAM 703 and executed by the computing unit 701. Alternatively, in other embodiments, the computing unit 701 may be configured to perform the method in the present disclosure by any other appropriate means (for example, by means of firmware).

Various implementations of the systems and technologies disclosed herein can be realized in a digital electronic circuit system, an integrated circuit system, a field programmable gate array (FPGA), an application-specific integrated circuit (ASIC), an application-specific standard product (ASSP), a system on chip (SOC), a complex programmable logic device (CPLD), computer hardware, firmware, software, and/or combinations thereof. Such implementations may include implementation in one or more computer programs that are executable and/or interpretable on a programmable system including at least one programmable processor, which can be special or general purpose, configured to receive data and instructions from a storage system, at least one input apparatus, and at least one output apparatus, and to transmit data and instructions to the storage system, the at least one input apparatus, and the at least one output apparatus.

Program codes configured to implement the methods in the present disclosure may be written in any combination of one or more programming languages. Such program codes may be supplied to a processor or controller of a general-purpose computer, a special-purpose computer, or another programmable data processing apparatus to enable the function/operation specified in the flowchart and/or block diagram to be implemented when the program codes are executed by the processor or controller. The program codes may be executed entirely on a machine, partially on a machine, partially on a machine and partially on a remote machine as a stand-alone package, or entirely on a remote machine or a server.

In the context of the present disclosure, machine-readable media may be tangible media which may include or store programs for use by or in conjunction with an instruction execution system, apparatus or device. The machine-readable media may be machine-readable signal media or machine-readable storage media. The machine-readable media may include, but are not limited to, electronic, magnetic, optical, electromagnetic, infrared, or semiconductor systems, apparatuses or devices, or any suitable combinations thereof. More specific examples of machine-readable storage media may include electrical connections based on one or more wires, a portable computer disk, a hard disk, an RAM, an ROM, an erasable programmable read only memory (EPROM or flash memory), an optical fiber, a compact disk read only memory (CD-ROM), an optical storage device, a magnetic storage device, or any suitable combination thereof.

To provide interaction with a user, the systems and technologies described here can be implemented on a computer. The computer has: a display apparatus (e.g., a cathode-ray tube (CRT) or a liquid crystal display (LCD) monitor) for displaying information to the user; and a keyboard and a pointing apparatus (e.g., a mouse or trackball) through which the user may provide input for the computer. Other kinds of apparatuses may also be configured to provide interaction with the user. For example, a feedback provided for the user may be any form of sensory feedback (e.g., visual, auditory, or tactile feedback); and input from the user may be received in any form (including sound input, speech input, or tactile input).

The systems and technologies described herein can be implemented in a computing system including background components (e.g., as a data server), or a computing system including middleware components (e.g., an application server), or a computing system including front-end components (e.g., a user computer with a graphical user interface or web browser through which the user can interact with the implementation mode of the systems and technologies described here), or a computing system including any combination of such background components, middleware components or front-end components. The components of the system can be connected to each other through any form or medium of digital data communication (e.g., a communication network). Examples of the communication network include: a local area network (LAN), a wide area network (WAN), and the Internet.

The computer system may include a client and a server. The client and the server are generally far away from each other and generally interact via the communication network. A relationship between the client and the server is generated through computer programs that run on a corresponding computer and have a client-server relationship with each other. The server may be a cloud server, a distributed system server, or a server combined with blockchain.

It should be understood that the steps can be reordered, added, or deleted using the various forms of processes shown above. For example, the steps described in the present disclosure may be executed in parallel or sequentially or in different sequences, provided that desired results of the technical solutions disclosed in the present disclosure are achieved, which is not limited herein.

The above specific implementations do not limit the protection scope of the present disclosure. Those skilled in the art should understand that various modifications, combinations, sub-combinations, and replacements can be made according to design requirements and other factors. Any modifications, equivalent substitutions and improvements made within the spirit and principle of the present disclosure all should be included in the protection scope of the present disclosure.

What is claimed is:

1. An entity linking method, comprising:
acquiring a target entity in a knowledge base and most relevant to a to-be-linked entity in a specified statement; and
deciding, based on a preset linking decision strategy, whether to link the to-be-linked entity to the target entity in the knowledge base.

2. The method of claim 1, wherein the acquiring a target entity in a knowledge base and most relevant to a to-be-linked entity in a specified statement comprises:
acquiring correlation between the to-be-linked entity in the specified statement and each of a plurality of candidate entities with the same name in the knowledge base;
acquiring a type of the to-be-linked entity, types of the candidate entities, prior probabilities that the to-be-linked entity is linked to the candidate entities, and coherence features between the to-be-linked entity and the candidate entities; and
acquiring the target entity most relevant to the to-be-linked entity from the plurality of candidate entities in the knowledge base based on at least one of the correlation between the to-be-linked entity and the candidate entities, the type of the to-be-linked entity, the types of the candidate entities, the prior probabilities that the to-be-linked entity is linked to the candidate entities, and the coherence features between the to-be-linked entity and the candidate entities.

3. The method of claim 2, wherein the acquiring correlation between the to-be-linked entity in the specified statement and each of a plurality of candidate entities with the same name in the knowledge base comprises:
predicting, by using a pre-trained text matching model, the correlation between the to-be-linked entity in the specified statement and the corresponding candidate entities based on the specified statement, text information of the to-be-linked entity, and text information of attribute description of the candidate entities in the knowledge base.

4. The method of claim 2, wherein the acquiring the target entity most relevant to the to-be-linked entity from the plurality of candidate entities in the knowledge base based on at least one of the correlation between the to-be-linked entity and the candidate entities, the type of the to-be-linked entity, the types of the candidate entities, the prior probabilities that the to-be-linked entity is linked to the candidate entities, and the coherence features between the to-be-linked entity and the candidate entities comprises:
acquiring, by using a pre-trained feature fusion ranking module, the target entity most relevant to the to-be-linked entity from the plurality of candidate entities in the knowledge base based on at least one of the correlation between the to-be-linked entity and the candidate entities, the type of the to-be-linked entity, the types of the candidate entities, the prior probabilities that the to-be-linked entity is linked to the candidate entities, and the coherence features between the to-be-linked entity and the candidate entities.

5. The method of claim 1, wherein the deciding, based on a preset linking decision strategy, whether to link the to-be-linked entity to the target entity in the knowledge base comprises:
deciding, based on a pre-trained linking decision model, whether to link the to-be-linked entity to the target entity in the knowledge base.

6. The method of claim 2, wherein the deciding, based on a preset linking decision strategy, whether to link the to-be-linked entity to the target entity in the knowledge base comprises:
deciding, based on a pre-trained linking decision model, whether to link the to-be-linked entity to the target entity in the knowledge base.

7. The method of claim 3, wherein the deciding, based on a preset linking decision strategy, whether to link the to-be-linked entity to the target entity in the knowledge base comprises:
deciding, based on a pre-trained linking decision model, whether to link the to-be-linked entity to the target entity in the knowledge base.

8. The method of claim 4, wherein the deciding, based on a preset linking decision strategy, whether to link the to-be-linked entity to the target entity in the knowledge base comprises:
deciding, based on a pre-trained linking decision model, whether to link the to-be-linked entity to the target entity in the knowledge base.

9. The method of claim 5, wherein the deciding, based on a pre-trained linking decision model, whether to link the to-be-linked entity to the target entity in the knowledge base comprises:
acquiring, by using the pre-trained linking decision model, a probability that the to-be-linked entity is linked to the target entity based on at least one of correlation between the to-be-linked entity and the target entity, the type of the to-be-linked entity, a type of the target entity, a prior probability that the to-be-linked entity is linked to the target entity, coherence features between the to-be-linked entity and the target entity, and features of the to-be-linked entity.
judging whether the probability is greater than a preset probability threshold; and
linking the to-be-linked entity to the target entity if yes.

10. The method of claim 9, wherein the deciding, based on a pre-trained linking decision model, whether to link the to-be-linked entity to the target entity in the knowledge base further comprises:
determining that no to-be-linked entity exists in the knowledge base if the probability is no greater than the preset probability threshold.

11. An electronic device, comprising:
at least one processor; and
a memory communicatively connected with the at least one processor;
wherein the memory stores instructions executable by the at least one processor, and the instructions are executed by the at least one processor to enable the at least one processor to perform an entity linking method, wherein the entity linking method comprises:
acquiring a target entity in a knowledge base and most relevant to a to-be-linked entity in a specified statement; and
deciding, based on a linking decision strategy, whether to link the to-be-linked entity to the target entity in the knowledge base.

12. The electronic device of claim 11, wherein the acquiring a target entity in a knowledge base and most relevant to a to-be-linked entity in a specified statement comprises:
acquiring correlation between the to-be-linked entity in the specified statement and each of a plurality of candidate entities with the same name in the knowledge base;
acquiring a type of the to-be-linked entity, types of the candidate entities, prior probabilities that the to-be-linked entity is linked to the candidate entities, and coherence features between the to-be-linked entity and the candidate entities; and
acquiring the target entity most relevant to the to-be-linked entity from the plurality of candidate entities in the knowledge base based on at least one of the correlation between the to-be-linked entity and the candidate entities, the type of the to-be-linked entity, the types of the candidate entities, the prior probabilities that the to-be-linked entity is linked to the candidate entities, and the coherence features between the to-be-linked entity and the candidate entities.

13. The electronic device of claim 12, wherein the acquiring correlation between the to-be-linked entity in the specified statement and each of a plurality of candidate entities with the same name in the knowledge base comprises:
predicting, by using a pre-trained text matching model, the correlation between the to-be-linked entity and the corresponding candidate entities based on the specified statement, text information of the to-be-linked entity, and text information of attribute description of the candidate entities in the knowledge base.

14. The electronic device of claim 12, wherein the acquiring the target entity most relevant to the to-be-linked entity from the plurality of candidate entities in the knowledge base based on at least one of the correlation between the to-be-linked entity and the candidate entities, the type of the to-be-linked entity, the types of the candidate entities, the prior probabilities that the to-be-linked entity is linked to the candidate entities, and the coherence features between the to-be-linked entity and the candidate entities comprises:
acquiring, by using a pre-trained feature fusion ranking module, the target entity most relevant to the to-be-linked entity from the plurality of candidate entities in the knowledge base based on at least one of the correlation between the to-be-linked entity and the candidate entities, the type of the to-be-linked entity, the types of the candidate entities, the prior probabilities that the to-be-linked entity is linked to the candidate entities, and the coherence features between the to-be-linked entity and the candidate entities.

15. The electronic device of claim 11, wherein the deciding, based on a preset linking decision strategy, whether to link the to-be-linked entity to the target entity in the knowledge base comprises:
deciding, based on a pre-trained linking decision model, whether to link the to-be-linked entity to the target entity in the knowledge base.

16. The electronic device of claim 12, wherein the deciding, based on a preset linking decision strategy, whether to link the to-be-linked entity to the target entity in the knowledge base comprises:
deciding, based on a pre-trained linking decision model, whether to link the to-be-linked entity to the target entity in the knowledge base.

17. The electronic device of claim 13, wherein the deciding, based on a preset linking decision strategy, whether to link the to-be-linked entity to the target entity in the knowledge base comprises:
deciding, based on a pre-trained linking decision model, whether to link the to-be-linked entity to the target entity in the knowledge base.

18. The electronic device of claim 15, wherein the deciding, based on a pre-trained linking decision model, whether to link the to-be-linked entity to the target entity in the knowledge base comprises:
acquiring, by using the pre-trained linking decision model, a probability that the to-be-linked entity is linked to the target entity based on at least one of correlation between the to-be-linked entity and the target entity, the type of the to-be-linked entity, a type of the target entity, a prior probability that the to-be-linked entity is linked to the target entity, coherence features between the to-be-linked entity and the target entity, and features of the to-be-linked entity;
judging whether the probability is greater than a preset probability threshold; and
linking the to-be-linked entity to the target entity if yes.

19. The electronic device of claim 18, wherein the deciding, based on a pre-trained linking decision model, whether to link the to-be-linked entity to the target entity in the knowledge base further comprises:
determining that no to-be-linked entity exists in the knowledge base if the probability is no greater than the preset probability threshold.

20. A non-transitory computer readable storage medium with computer instructions stored thereon, wherein the computer instructions are used for causing an entity linking method, wherein the entity linking method comprises:
acquiring a target entity in a knowledge base and most relevant to a to-be-linked entity in a specified statement; and
deciding, based on a preset linking decision strategy, whether to link the to-be-linked entity to the target entity in the knowledge base.
